(19) United States
(12) Patent Application Publication
(10) Pub. No.: US 2014/0348613 A1
(43) Pub. Date: Nov. 27, 2014

(54) Nut And/Or Bolt Head With Jackscrew Actuated Lock Washer Stack

(71) Applicant: John D. Davis, Las Vegas, NV (US)

(72) Inventor: John D. Davis, Las Vegas, NV (US)

(21) Appl. No.: 13/898,689

(22) Filed: May 21, 2013

(51) Int. Cl. F16B 39/24

(52) U.S. Cl. CPC F16B 39/24
USPC 411/330

(57) ABSTRACT

A jackscrew nut and/or bolt head assembly includes a load washer that may be selectively engaged via the jackscrews. Spherical faces at the washer top are held in alignment with corresponding spherical jackscrew bottoms via axially interlocking pins. The pins may partially extend radial beyond the circumference of the main body of the nut and/or bolt head thereby defining ridges of an outside tool access profile. The assembly may be initially tightened via a primary torque induced onto the pins and the main body. Final tightening and load setting may be provided via the jackscrews whereby a lock feature of the load washer may be engaged and the assembly secured against inadvertent loosening. The load washer may be part of a lock washer stack including a lock washer. The interface between the lock and load washer may be configured for ratchet locking and/or helical wedge locking of the central thread.

### FIELD OF INVENTION

The present invention relates to jackscrew nuts and bolt heads. In particular, the present invention relates to jackscrew nuts and bolt head assemblies with jackscrew actuated position locking.

### BACKGROUND OF INVENTION

Jackscrew nuts and bolt heads circumvent the need for high power torque wrenches, especially with larger bolt diameters. Instead of having to tighten one nut or bolt head with high torque and big tool to bring the respective central thread connection to the required load, a number of circular arrayed jackscrews that are screwed in the nut and/or bolt head are sequentially tightened with comparatively low torques requiring only comparatively small tools. The jackscrews thereby lift off the nut and/or bolt head from their flange position as is well known in the art.

It is a common need to secure a nut and/or bolt against inadvertent loosening. This also applies for jackscrew nuts and bolts, which require special consideration on one hand because of the stress concentrations induced by jackscrew bottoms. On the other hand, dual actuated jackscrew nuts and bolts provide for separated primary and secondary tightening and loosening actuation via the main body and via the jackscrews, which may be advantageously utilized to selectively lock and unlock washers. Therefore, there exists a need for a jackscrew nut and/or bolt tightening assembly including a correspondingly configured lock washer and/or lock washer stack. The present invention addresses this need.

### SUMMARY

A jackscrew nut and/or bolt head assembly includes a circumferentially and radial interlocked load washer. Spherical faces at the load washer top are thereby held in alignment with corresponding spherical jackscrew bottoms. The spherical-to-spherical jackscrew-washer interface assures evenly distributed contact pressures during out of angle elastic jackscrew displacement and minimizes galing.

The circumferential and radial interlocked load washer provides further for a transfer of a primary torque exerted onto the main nut or bolt head body via an assembly torque access, which may be a number of axially extending pins that partially extend radial beyond a circumference of the main body. The pins may extend below the bottom of the main body and axially slide able interlock with correspondingly shaped washer interlocks. In case of a single employed load washer, it may feature radial serrations at its bottom to bite into the attachment flange or a protrusion to interlock with a corresponding recess or feature at the attachment flange.

The load washer may be part of a lock washer stack in which an additional lock washer is positioned below the load washer. In that case, only the load washer is in an interlock with the main body. The load washer may have a larger central hole diameter than the lock washer and a rim of the main body may extend through the central load washer hole and access a smooth bearing face at the lock washer top. During initial tightening via the main body and with loose jackscrews, the rim may slide on the bearing face and transfer the initial tightening load directly onto the load washer with low friction. During final tightening, the jackscrews are pressed against the load washer and force it to engage with the lock washer via a ratchet interface between them. The final set load is then transferred from the main body across the jackscrews onto the load washer and across the ratchet interface onto the lock washer thereby effectively locking the jackscrew nut and/or bolt. The ratchet interface may include a helical interface that has an interface pitch substantially larger than a thread pitch of the central thread and that has an interface pitch direction that is the same as thread pitch direction of the central thread. The helical interface may thereby effectively provide a rotational wedge lock against the main body becoming loose.

To unlock the jackscrew nut and/or bolt, the jackscrews may be initially loosened. In case of only a load washer employed, the preload is sufficiently reduced for the serrations to loose their bite. In case of a lock washer stack with ratchet interface and main body rim employed, the ratchet interface disengages and the main body rim comes again into contact with the lock washer bearing face. In case of the helical interface, sufficient clearance is established between jackscrews and load washer such that during a following loosening of the main body. sufficient axial suspension is established for the helical interface to slide unrestricted in wedging direction.

### BRIEF DESCRIPTION OF THE FIGURES

FIG. 1A is a top down perspective view of a first embodiment of the invention in a nut configuration.

FIG. 1B is an angled cut view of FIG. 1A.

FIG. 1C is a top down perspective view of a load washer of FIGS. 1A, 1B.

FIG. 10 is a bottom up perspective view of FIG. 1C.

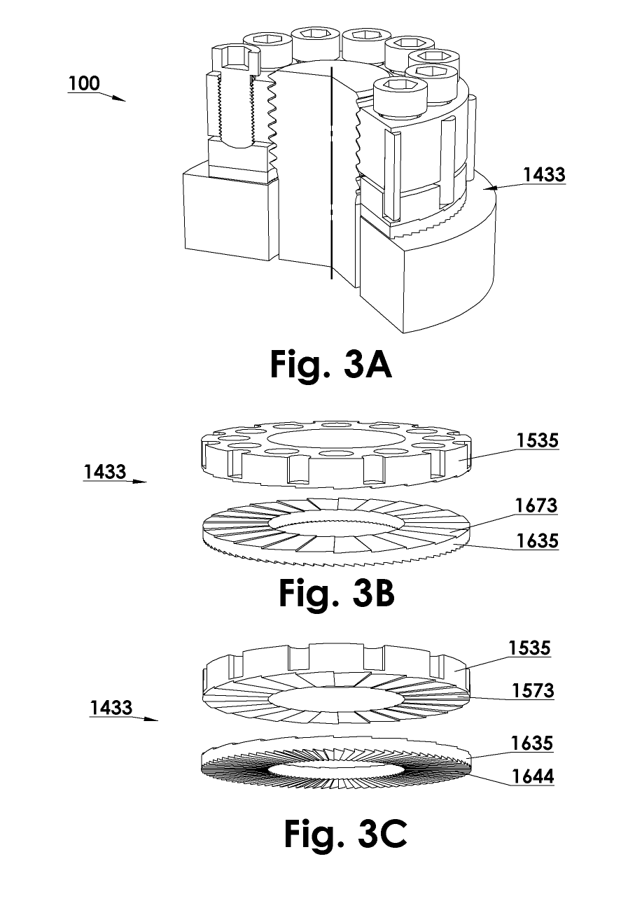

FIG. 2A is an angled top down perspective cut view of a second embodiment of the invention in a nut configuration.

FIG. 2B is a top down perspective exploded view of a load washer stack of FIG. 2A.

FIG. 2C is a bottom up perspective exploded view of FIG. 2B.

FIG. 3A is an angled top down perspective cut view of a third embodiment of the invention in a nut configuration.

FIG. 3B is a top down perspective exploded view of a load washer stack of FIG. 3A.

FIG. 3C is a bottom up perspective exploded view of FIG. 3B.

### DETAILED DESCRIPTION

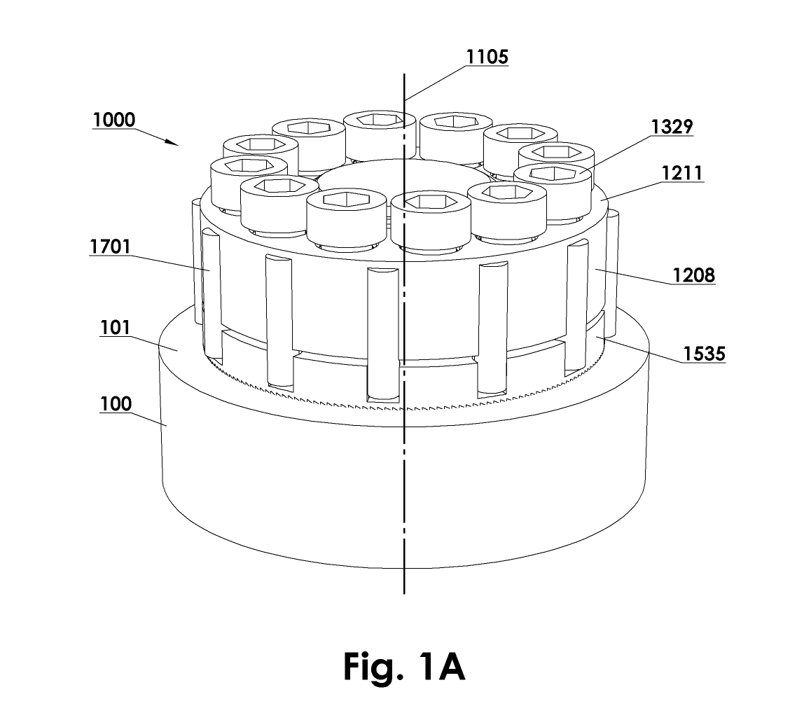

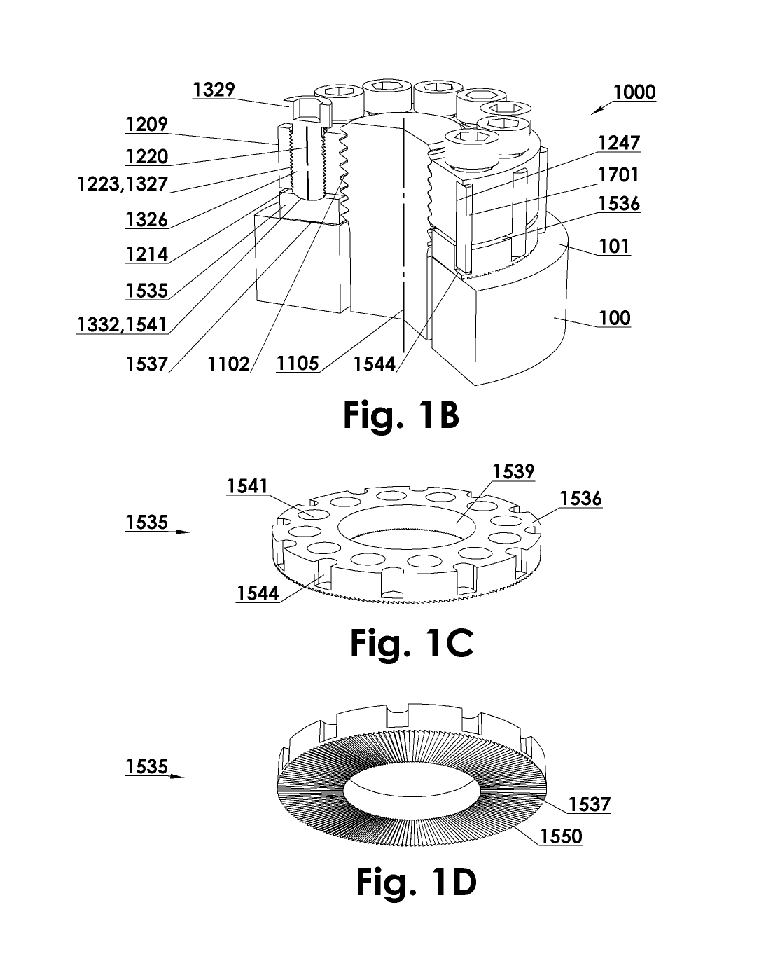

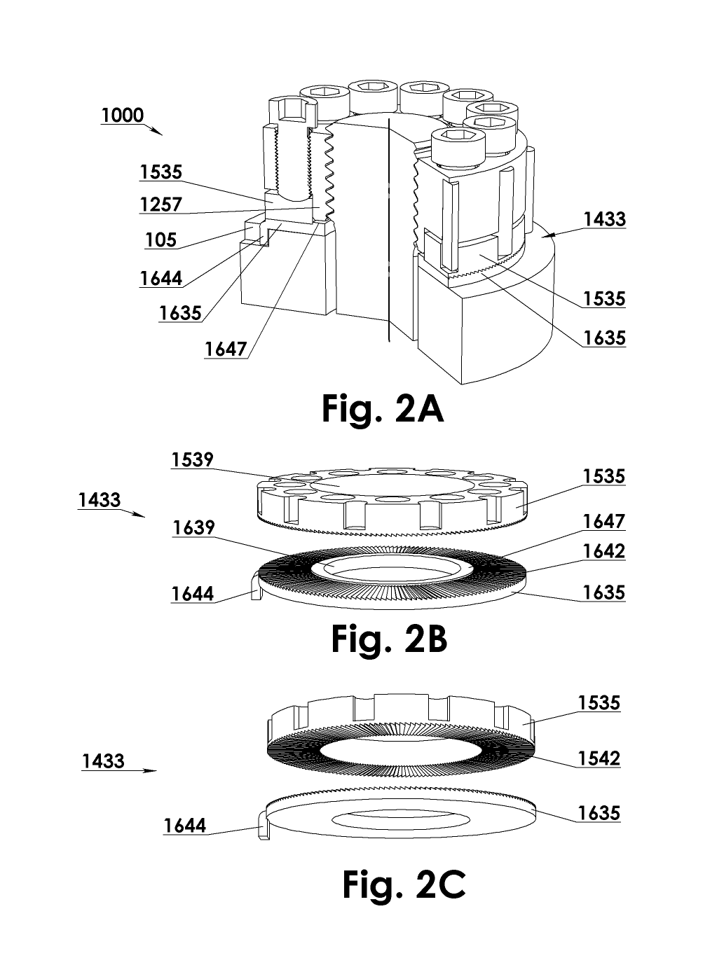

According to a first embodiment of the invention and referring to FIG. 1A-1D, a jackscrew tightening assembly 1000 may feature a central thread 1102 with a thread axis 1105. In case of the jackscrew tightening assembly 1000 being a nut, the central thread 1102 may be an internal thread. In case of the jackscrew tightening assembly 1000 being a bolt head, the central thread 1102 may be an external thread. Parts of the jackscrew tightening assembly 1000 are a main body 1208, jackscrews 1326, a load washer 1535 and interlock pins 1701. The main body 1208 is extending radial outward with respect to the central thread 1102 as is well known for jackscrew nuts and/or bolts. The main body 1208 has a main top 1211, a main bottom 1214 that is opposite the main top 1211 in axial direction with respect to the central thread axis 1105, through holes 1217 with a through hole axis 1220 that is in an offset to the central thread axis 1105, and a secondary thread 1223 at least along a portion of the through hole 1217. The jackscrews 1326 are extending through respective through holes 1217, and engaging via their jackscrew threads 1327 with the respective secondary threads 1223. The jackscrews 1326 have jackscrew heads 1329 facing away from the main bottom 1214 and spherical bottoms 1332 facing away from the main top 1211. The jackscrews 1326 are preferably arrayed in a number around the central thread 1102 such that upon even tightening of all jackscrews 1326, the axial sum of all their individually exerted axial loads is transferred onto the central thread 1102 in a balanced fashion via the main body 1208 as may be well appreciated by anyone skilled in the art.

The load washer 1535 is adjacent the main bottom 1214 and surrounding the central thread 1102. The load washer 1535 has a washer top 1538 that is facing the main bottom 1214 and a number of spherical faces 1541 that are formed into the washer top 1538. The spherical faces 1541 are matching their respective spherical bottoms 1332. They are in substantial axial alignment with them and rotationally symmetric with respect to the central thread axis 1105. The load washer 1535 is at least circumferentially but preferably also radial held with the main body 1008 via interlock pins 1701 that are fitted in respective washer interlocks 1544 provided by the load washer 1535 and body interlocks 1247 provided by the main body 1208.

The interlock pins 1701 are preferably partially extending radial beyond a body circumference 1209 of the main body 1208, thereby defining ridges in an circumferential tool access for external tool access of and torque transfer to the main body 1208 around the central thread axis 1105 as may be well appreciated by anyone skilled in the art. The interlock pins 1701 are preferably press fitted into the body interlocks 1247 and axially slide able in the washer interlocks 1544.

The load washer 1535 may have at its first washer bottom 1537 a lock feature such as radial serrations 1550. In the single washer configuration of the first embodiment, during initial tightening via the main body 1208, the radial serrations slide on the flange top 101. Upon final tightening of the jackscrews 1326, the radial serrations 1550 bite into the flange top 101 such that inadvertent loosening of the central thread 1102 is opposed.

Part of a second embodiment as in FIGS. 2A-2C and a third embodiment as in FIGS. 3A-3C is a lock washer stack 1433 that includes the load washer 1535 and a lock washer 1635. The lock washer stack 1433 is specifically configured to take advantage of the dual actuation for tightening and loosening provided by the tool access feature of the main body 1208 and the jack screws 1326. Thus, the main body 1208 may be locked and unlocked through the tightening and loosening of the jackscrews 1326. In the lock washer stack 1433, the load washer 1538 remains is features on its first washer top 1536 such as the spherical faces 1541 and the washer interlocks 1544 as explained under the first embodiment.

The lock washer 1635 features on its second bottom 1637 the lock feature(s), which may be in the second embodiment a coupling protrusion 1644 and in the third embodiment radial serrations 1650. On the first washer bottom 1537 is a first ratchet feature 1542. On a second washer top 1636 of the lock washer 1635 is a second ratchet feature 1642 mating the first ratchet feature 1542 such that upon contact of the first washer bottom 1537 with the second washer top 1636 a circumferentially at least one directional locking in loosening direction of the central thread 1102 is provided between first and second ratchet features 1542, 1642.

In the second embodiment, the coupling protrusion 1644 is preferably a bend able and/or bent lip at the circumference of the lock washer 1635. It may engage with a flange lock 105 such as a prefabricated hole, groove or edge as is well known in the art. Nevertheless, the scope of the invention includes any configuration of the coupling protrusion 1644 to provide a form based interlocking with any structure on the attachment site such as flange 100 as may be well appreciated by anyone skilled in the art. Due to the form interlock, the lock washer 1635 of the second embodiment is rigidly held against rotation as soon as it positioned at the attachment site. The second ratchet feature 1642 and the first ratchet feature 1542 have a mating ratcheting configuration such that upon unloaded contact between the first washer bottom 1537 and the second washer top 1636, the load washer 1535 is rotationally unrestricted with respect to the lock washer 1636 and such that the load washer 1535 is rotationally restricted with respect to the lock washer 1635 upon loaded contact between the first washer bottom 1537 and the second washer top 1636. The loaded contact is induced via the spherical faces 1541 and via the second washer bottom 1637 resting on the attachment site 100.

As shown in FIG. 2A, the dual actuation may be additionally utilized by employment of a bottom rim 1257 in conjunction with a bearing face 1647 that is inside of the second ratchet feature 1642 as shown in FIG. 2B. A second through hole 1639 is substantially smaller then the first through hole 1539 and just big enough to fit around the central thread 1102. The bottom rim 1257 extends through the first through hole 1539 such that it axially contacts the bearing face 1647 while the jackscrews 1326 are released. Hence and because of the dual actuation, the main body 1208 may initially be tightened with low friction by withholding itself directly on the bearing face 1647 and bypassing the ratchet interface 1542, 1642. The load washer 1535 rotates with the main body 1208 and its spherical faces 1541 aligned with the spherical jackscrew bottoms 1332, but it remains axially loose. Once the initial tightening is completed and a substantial portion of the overall load displacement absorbed by the central thread 1102, secondary tightening of the jackscrews 1326 brings the jackscrew tightening assembly 1000 to full load with relatively little final displacement. The ratchet features 1542, 1642 engage and lock the jackscrew tightening assembly 1000. During loosening of it, initial loosening of the jackscrews 1326 releases the ratchet features 1542, 1642 and brings the bottom rim 1257 again in contact with the bearing face 1647. The central thread 1102 may be then loosened with relatively low friction as may be clear to anyone skilled in the art. Bottom rim 1257 and bearing face 1647 may be employed with the second embodiment as depicted in FIGS. 2A-2C and also with the third embodiment of the invention.

First and second ratchet features 1542, 1642 may be configured with a one directional circumferential lock as depicted in the FIGS. 2A-2C, which provides a full lock even in the case the jackscrews 1326 becoming slightly loose. The one directional circumferential lock may be particularly advantageous in conjunction with the coupling protrusion 1644 such that a continuous form locking is established between the attachment flange 100 and the main body 1208 across the lock washer 1635 and the load washer 1535.

Referring to FIGS. 3A-3C, the first and the second ratchet features 1542, 1642 include a helical interface 1573, 1673 that has an interface pitch substantially larger than a thread pitch of the central thread 1102 and that has an interface pitch direction that is the same as a thread pitch direction of the central thread 1102. That way, once the jackscrews 1326 are finally tightened, a forced thread wedging is established via the rotational coupling of the load washer 1536 with the main body 1208. Any loosening rotation of the main body 1208 around the central thread 1102 would force the load washer 1536 to rotate as well and the helical interface 1573, 1673 to slide and induce an axial displacement that would exceed the axial displacement due to loosening of the central thread 1102. The third embodiment may be employed in conjunction with a lock feature such as radial serrations 1650 as shown in FIGS. 3A-3C or in conjunction with a coupling protrusion 1644 as depicted in FIGS. 2A-2C.

At least one of the jackscrews 1326, the main body 1208 or the interlock pins 1701 may be permanently magnetic to have the load washer 1535 lift off the lock washer 1635 once the jackscrews 1326 are loosened. Nevertheless, preferably the jackscrews 1326 may be preferably magnetic with an alternate magnetic polarity such that magnetic loops are established across the load washer 1535 and not the lock washer 1635. Alternately, load and lock washers 1535, 1635 may be permanent magnetic with opposing polarity such that they push each other apart as may be clear to anyone skilled in the art.

Accordingly, the scope of the Figures and the Specification above is set forth by the following claims and their legal equivalent:

What is claimed is:

1. A lock washer stack comprising:
a. a load washer comprising:
i. a first washer top and a first washer bottom;
ii. a first washer through hole;
iii. a spherical face that is on said first washer top and that is rotationally symmetric with respect to a contact axis adjacent said washer through hole;
iv. a first ratchet feature that is on said first washer bottom;
b. a lock washer comprising:
i. a second washer top and a second washer bottom;
ii. a second ratchet feature that is on said second washer top; and
iii. a lock feature that is on said second washer bottom; and
wherein said second ratchet feature and said first ratchet feature have a mating ratcheting configuration such that upon unloaded contact between said first washer bottom and said second washer top said load washer is rotationally unrestricted with respect to said lock washer and such that said load washer is rotationally restricted with respect to said lock washer upon loaded contact between said first washer bottom and said second washer top, said loaded contact being via said spherical face and via said second washer bottom.

2. The lock washer stack of claim 1, wherein said load washer further comprises a washer interlock recessed from said first washer top.

3. The lock washer stack of claim 2, wherein said washer interlock is radially recessed in a circumference of said load washer.

4. The lock washer stack of claim 1, wherein said lock washer further comprises:
a. a second washer through hole that is substantially smaller than said first washer through hole, and
b. a bearing face that is inside of said second ratchet feature and that is axially accessible through said first washer through hole while said first ratchet feature and said second ratchet feature are in contact.

5. The lock washer stack of claim 1, wherein said lock feature includes a radial serration.

6. The lock washer stack of claim 1, wherein said lock feature is a coupling protrusion that is protruding away from said second washer bottom.

7. A jackscrew tightening assembly comprising:
a. a central thread with a central thread axis;
b. a main body radially outward extending with respect to said central thread, said main body comprising:
i. a main top;
ii. a main bottom that is opposite said main top in axial direction with respect to said central thread axis;
iii. a through hole with a through hole axis being in an offset to said central thread axis;
iv. a secondary thread at least along a portion of said through hole;
v. a body interlock extending from said main bottom;
c. a jackscrew that is extending through said through hole and that is engaging with said secondary thread, said jackscrew comprising:
i. a jackscrew head that is facing away from said main bottom;
ii. a spherical bottom that is facing away from said main top;
d. a load washer that is adjacent to said main bottom and that is concentric to said central thread, said load washer comprising:
i. a first washer top that is facing said main bottom and a first washer bottom that is facing away from said main bottom;
ii. a spherical face that is on said first washer top and that is matching said spherical bottom;
iii. a washer interlock that is in an axial coupling with said body interlock such that said spherical face is in axial alignment with said spherical bottom with respect to said central thread axis; and
iv. a lock feature that is on said first washer bottom.

8. The jackscrew tightening assembly of claim 7, wherein said body interlock and said washer interlock are cavities and said jackscrew tightening assembly further comprises an interlock pin that is rigidly held in said one of said body interlock and said washer interlock and that is axially slide able in one other of said washer interlock and said body interlock thereby establishing said axial coupling.

9. The jackscrew tightening assembly of claim 8, wherein said pin partially extends radial beyond a circumference of said main body.

10. The jackscrew tightening assembly of claim 7, wherein said lock feature includes a radial serration.

11. The jackscrew tightening assembly of claim 7, wherein said lock feature is a protrusion that is protruding away from said second washer bottom.

12. The jackscrew tightening assembly of claim 7 being one of a nut and a bolt.

13. A jackscrew tightening assembly comprising:
a. a central thread with a central thread axis;
b. a main body radially outward extending with respect to said central thread, said main body comprising:
i. a main top;
ii. a main bottom that is opposite said main top in axial direction with respect to said central thread axis;
iii. a through hole with a through hole axis being in an offset to said central thread axis;
iv. a secondary thread at least along a portion of said through hole;
v. an body interlock extending from said main bottom;
c. a jackscrew that is extending through said through hole and that is engaging with said secondary thread, said jackscrew comprising:
i. a jackscrew head that is facing away from said main bottom;
ii. a spherical bottom that is facing away from said main top;
d. a load washer that is adjacent to said main bottom and that is concentric to said central thread, said load washer comprising:
i. a first washer top that is facing said main bottom and a first washer bottom that is facing away from said main bottom;
ii. a spherical face that is on said first washer top and that is matching said spherical bottom;
iii. a washer interlock that is an axial mate with said body interlock such that said spherical face is in axial alignment with said spherical bottom with respect to said central thread axis;
iv. a first ratchet feature that is on said first washer bottom;
e. a lock washer comprising:
j. a second washer top and a second washer bottom;
ii. a second ratchet feature that is on said second washer top, said second ratchet feature mating said first ratchet feature such that upon contact of said first washer bottom with said second washer top a circumferentially at least one directional locking is provided between said first ratchet feature and said second ratchet feature; and
iii. a lock feature that is on said second washer bottom.

14. The jackscrew tightening assembly of claim 7, wherein said body interlock and said washer interlock are cavities and said jackscrew tightening assembly further comprises an interlock pin that is rigidly held in said one of said body interlock and said washer interlock and that is axially slide able in one other of said washer interlock and said body interlock thereby establishing said axial coupling.

15. The jackscrew tightening assembly of claim 14, wherein said interlock pin partially extends radial beyond a circumference of said main body.

16. The jackscrew tightening assembly of claim 13, wherein said main body further comprises a bottom rim that is axially extending through a first through hole of said load washer and wherein said lock washer further comprises:
a. a second through hole that is substantially smaller than said first washer through hole, and
b. a bearing face that is inside of said second ratchet feature such that said bottom rim is axially contacting said bearing face while said jackscrew is released.

17. The jackscrew tightening assembly of claim 13, wherein said first and said second ratchet features include a helical interface that has an interface pitch substantially larger than a thread pitch of said central thread and that has an interface pitch direction that is the same as a thread pitch direction of said central thread.

18. The jackscrew tightening assembly of claim 13, wherein said lock feature includes a radial serration.

19. The jackscrew tightening assembly of claim 13, wherein said lock feature is a protrusion that is protruding away from said second washer bottom.

20. The jackscrew tightening assembly of claim 13 being one of a nut and a bolt.
